(19) United States
(12) Patent Application Publication
(10) Pub. No.: US 2009/0110286 A1
(43) Pub. Date: Apr. 30, 2009

(54) Detection method

(76) Inventors: Christian Nunn, Hueckeswagen (DE); Stefan Mueller-Schneiders, Duesseldorf (DE)

Correspondence Address: DELPHI TECHNOLOGIES, INC., M/C 480-410-202, PO BOX 5052, TROY, MI, 48007, US

(21) Appl. No.: 12/229,220

(22) Filed: Aug. 20, 2008

(30) Foreign Application Priority Data
Aug. 20, 2007 (EP) 07016308.4

(51) Int. Cl. G06K 9/46

(52) U.S. Cl. 382/190

(57) ABSTRACT

The invention relates to a method for the detection of a symmetrical object of a known shape, in particular of a road sign, preferably associated with a road, in an image of the environment in the range of view of an image taking device in particular arranged at a motor vehicle, in which an image is taken by means of the image taking device, at least one image region including image elements, which in each case exceeds a preset degree of symmetry, or a part thereof, is determined in the taken image or in an image generated from the taken image by image processing, a respective relevant image portion is determined with reference to the at least one image region or the part thereof for a subsequent shape recognition, and the shape recognition is carried out in each case only in the at least one relevant image portion to detect a potential image of the symmetrical object.

### TECHNICAL FIELD

The present invention relates to a method for the detection of a symmetrical object of a known shape, in particular of a road sign, preferably associated with a road, in an image of the environment in the range of view of an image taking device in particular arranged at a motor vehicle.

### BACKGROUND OF THE INVENTION

Systems for the recognition of road signs can be used to inform the driver of a motor vehicle of the road signs at the road, for example by projection onto the windshield of the motor vehicle via a head-up display of a graphic representation of a road sign detected at the road. Systems for the recognition of road signs can, however, also be used as driver assistance systems, for example to automatically reduce the driving speed to the permitted maximum speed when speeding.

Cameras are used for road sign recognition which take the environment in front of the motor vehicle and examine it for the presence of road signs. A road sign recognition can, for example, be carried out in two stages. In a first stage (detection), it is then a question of locating potential candidates for images of road signs in a taken image via a feature extraction. This can take place, for example, by means of a Hough transformation which serves for the recognition of geometrical shapes or by means of a color segmentation in which contiguous areas of the same color are recognized. The second stage (classification) has the object of first determining whether the respective candidate is actually an image of a road sign and, in the affirmative case, of then determining the type of the imaged road sign. This can be done, for example, by means of template matching.

Such a road sign recognition, which is carried out by a data processing device, however, requires a high computing effort which results in a high computing time. The robustness of such a road sign recognition is furthermore insufficient.

### SUMMARY OF THE INVENTION

It is the underlying object of the invention to set forth a possibility of cutting the computation time for the detection of symmetrical objects and/or to increase the robustness of a detection of this type.

This object is satisfied by a method of the initially named kind in which an image, in particular a digital image, is taken by means of the image taking device, in particular digital image taking device, at least one image region including image elements, which in each case exceeds a preset degree of symmetry, or a part thereof, is determined in the taken image or in an image generated from the taken image by image processing, a respective relevant image portion is determined with reference to the at least one image region or the part thereof for a subsequent shape recognition, and the shape recognition is carried out in each case only in the at least one relevant image portion to detect a potential image of the symmetrical object.

The detection of the symmetrical object can be divided into two method steps.

Since symmetrical objects in an image result in corresponding symmetrical image regions, those image regions which have at least a specific minimum degree of symmetry are looked for in the taken image or in the image derived from the taken image in a first method step. The respectively associated relevant image portion is then determined from such an image region or a part thereof. The part of the image region is in particular a preferably vertical symmetry line of the image region. The relevant image portion can, for example, be the associated image region or a region which includes the associated image region provided with an additional tolerance range.

Then a shape recognition is carried out only in the relevant image portions in a second method step. Methods known per se can be used for the shape detection, for example a Hough transformation for the recognition of circles and/or a method for the recognition of regular polygons such as is described in Barnes et al., “Regular Polygon Detection”, Tenth IEEE International Conference on Computer Vision (ICCV), 778, 2005.

Potential images of the symmetrical objects of known shape, which are in particular stationary, can be determined via the shape recognition which can then be verified and recognized in a subsequent classification, for example by means of template matching.

The symmetry detection provided before the shape detection makes it possible to substantially cut the computing time for the shape detection since it then no longer has to be carried out over the whole image, but can be restricted to some few relevant image portions. Furthermore, each of the image regions or each of the parts thereof already includes a prediction on the size to be expected of the image of a symmetrical object, with the size to be expected resulting directly from the size of the respective image region or part thereof. The additional symmetry detection requires a comparatively small computing time which is exceeded by a multiple by the gain in computing time for the shape detection. Furthermore, the robustness of the total detection is increased by the symmetry detection provided beforehand.

The at least one image region or the part thereof is preferably determined in an image generated by image processing, with an edge recognition or edge detection being carried out for the generation of the processed image. Methods known per se, for example known edge filters such as the Sobel operator, can be used for the edge detection. The generated image is preferably a binary edge image or a gradient image in which the edges of the images of the symmetrical objects are emphasized, provided they are present in the taken image. The subsequent symmetry detection can then be carried out with reference to the gradient image or to the binary edge image, whereby the computing time for the symmetry detection can be reduced. A gradient image is an image in which a respective gradient vector, i.e. a gradient value and a gradient direction, is associated with the image elements.

Furthermore, the symmetry of an image of an object in a taken image, in particular in a taken gray value image or in a gray value image generated from a taken image can be disturbed by illumination inhomogeneities. Different regions of the image can, for example, appear with different brightness on light incidence from the side. A gradient image or a binary edge image is less sensitive with respect to such disturbances. The robustness of the total detection is thereby further increased.

In accordance with an embodiment of the invention, the respective degree of symmetry is determined for the at least one image region by comparison of the gradient vectors of the image elements of the gradient image disposed opposite one another with respect to a line. This makes it possible to recognize symmetries reliably since, in the comparison of the mutually oppositely disposed image elements, the gradient directions of the respective image elements can also be taken into account so that, with mutually oppositely disposed image elements which admittedly coincide in their gradient values or which are similar to one another, but whose gradient directions are not oriented at least approximately in specular symmetry with the line, a symmetry value results which is smaller with respect to the respective image elements. Generally, however, any other known method and/or any method known from the prior art can also be used to determine the degree of symmetry.

The at least one image region preferably in each case has specular symmetry, in particular with respect to a preferably vertical line of symmetry or axis. This is in particular of advantage since most of the symmetrical objects associated with a road, in particular round or triangular road signs, have a symmetrical structure or a specular symmetrical structure with respect to a vertical axis.

In accordance with another embodiment of the invention, the determination of at least one image region or of the part thereof is only carried out in a selected region or a “region of interest” of the taken or generated image. A method step can therefore be provided before the determination of the at least one image region or of the part thereof which preselects a region in which symmetrical objects to be detected can occur at all. In contrast, no symmetrical objects are to be expected in the non-selected region of the taken image or generated image so that no detection has to be carried out here either. The computing time for the subsequent symmetry detection can thereby be reduced. The selected region and/or the non-selected region can be formed by a plurality of non-contiguous part regions. A method for the determination of a selected region is described, for example, in the European patent application filed at the European Patent Office by the applicant on Jul. 30, 2007 with the application number 07 014 924.0 and the title “Method for a recognition of an object” whose content in this respect is incorporated in the present application by reference.

The determination of the at least one image region or of the part thereof and/or the determination of the at least one relevant image portion is preferably carried out while taking account of a prediction of the size of the image of the object to be expected. The computing time for the determination of the at least one image region or of the part thereof and/or for the subsequent shape detection can hereby be reduced. The prediction can result directly from the size of the respective image region or part thereof, as is described above. Another method for the prediction of the size to be expected of the image of the object is described in the aforesaid European patent application filed at the European Patent Office by the applicant on Jul. 30, 2007 with the application number 07 014 924.0 and the title “Method for a recognition of an object” whose content in this respect is incorporated in the present application by reference.

A further subject of the invention is a computer program with programming code means to carry out the method described above when the program is carried out on a computer or on a corresponding computing unit.

A computer program product is also a subject of the invention having programming code means stored on a computer legible data carrier to carry out the method described above when the computer program is carried out on a computer or on a corresponding computing unit.

In this connection, a computer is understood as any desired data processing device with which the method can be carried out. They can in particular have digital signal processors and/or microprocessors with which the method can be carried out fully or in parts.

Finally, an object of the invention is an apparatus for the detection of a symmetrical object of known shape, in particular of a road sign, preferably associated with a road, in an image of the environment in the range of view of an image taking device in particular arranged at a motor vehicle, comprising a camera device for the taking of an image and a data processing device which is made for the carrying out of the method described above.

Further advantageous embodiments of the invention are set forth in the dependent claims, in the description and in the drawing.

### BRIEF DESCRIPTION OF THE INVENTION

The invention will be described in the following by way of example with reference to the drawing. There are shown, schematically in each case:

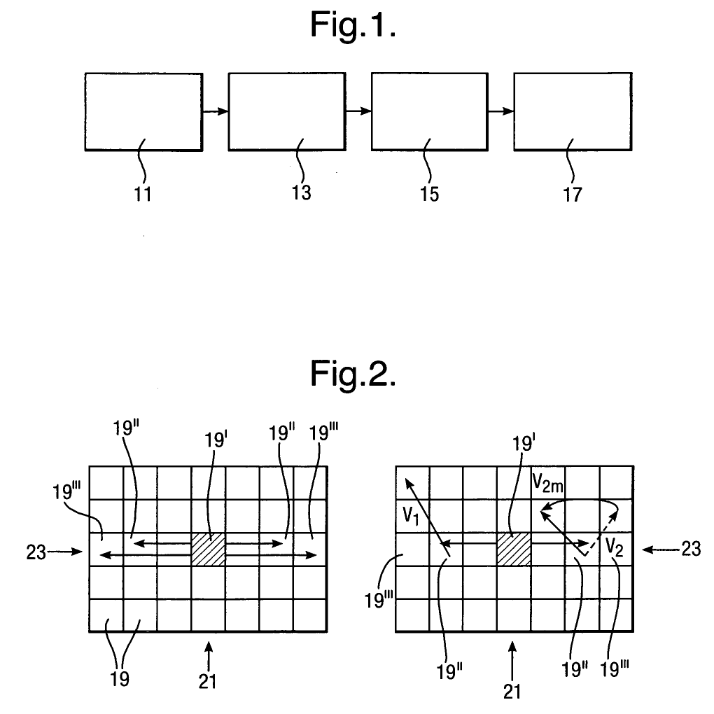

FIG. 1 is a block diagram in which a plurality of method steps for the detection of symmetrical objects are shown;

FIG. 2 is image elements of an image region for the illustration of the determination of a degree of symmetry; and

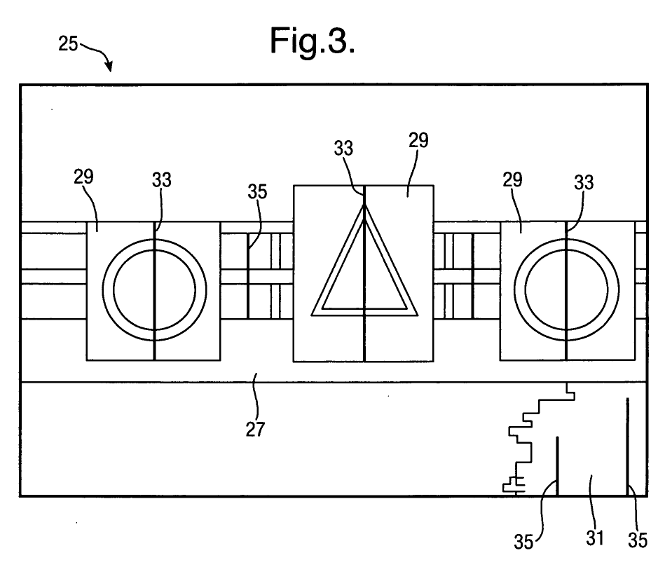

FIG. 3 is a gradient image which is generated from an image taken by means of a digital video camera and in which vertical symmetry lines are shown.

### DESCRIPTION OF THE PREFERRED EMBODIMENT

The detection stage of a method for road sign recognition is shown in FIG. 1.

For this purpose, a gray value image of the environment is first taken in the range of view of a digital video camera arranged at a motor vehicle in a first method step 11. Generally, however, a color image can also be taken which is subsequently converted into a gray value image.

Then, the gray value image is subjected to an edge recognition by means of a Sobel operator in a second method step 13, with a gradient image resulting. The gradient image is characterized in that a gradient vector, i.e. a gradient value and a gradient direction, is associated with each image element or pixel of the gradient image. Before or subsequently, a selected region (region of interest) is determined in the gray value image or in the gradient image in which road signs can generally occur. It is assumed in this connection that no road signs can occur in the non-selected region. The determination of the selected region is generally known and described, for example, in the aforesaid European patent application (application number 07 014 924.0).

Subsequently, in a third method step 15, vertical lines of symmetry are looked for in the selected region of the gradient image for image regions which each exceed a predetermined degree of horizontal specular symmetry, as will be explained in even more detail in the following with reference to FIG. 2. A relevant image portion from the gradient image is then respectively assigned to each of the vertical lines of symmetry. The respective relevant image portion substantially corresponds to that image region for which the respective line of symmetry was determined, but is spatially expanded by a tolerance range with respect to it.

Finally, in a fourth method step 17, a respective shape detection is carried out, and indeed solely in the region of the relevant image portions which include the vertical lines of symmetry. A shape detection in a gradient image, for example by means of a Hough transformation, is generally known from the prior art. The shape detection is facilitated in this connection in that the relevant image portion is in each case provided with a size to be expected of a road sign in each case at this position of the gradient image. The size to be expected is determined from the size of the respective vertical line of symmetry and from a prediction on the size to be expected in the region of the respective image portion in accordance with the method described in the aforesaid European patent application (application number 07 014 924.0).

To find the aforesaid lines of symmetry, each column of the gradient image within the selected region is checked as to whether the respective column, or a portion thereof represents a vertical line of symmetry for a specific image region. This is illustrated in FIG. 2 in which a plurality of contiguous pixels 19 arranged in rows and columns are shown. In order, for example, to determine for column 21 whether it includes a vertical line of symmetry, each pixel of the column 21 located inside the selected region is examined as to whether the line associated with the respective pixel has a horizontal specular symmetry within the selected region.

This is illustrated in FIG. 2 with reference to the pixel 19′ of the column 21, with pixel 19′ being arranged in line 23. To check whether the line 23 exceeds a preset degree of specular symmetry within the selected region with respect to the pixel 19′, in each two pixels are compared with one another, of which one is arranged to the left and one to the right of the pixel 19′, and which have the same spacing r from the pixel 19′. For example, the two pixels 19″, which are each horizontally offset by r=2 pixels with respect to the pixel 19′, or the two pixels 19′″, which are each horizontally offset by r=3 pixels with respect to the pixel 19′, are compared with one another.

In this connection, two respective pixels equally spaced apart from the pixel 19′ are compared with one another whose spacing is in an interval between a minimal spacing rₘᵢₙ and a maximum spacing rₘₐₓ from the pixel 19′. The limits rₘᵢₙ and rₘₐₓ of the interval are selected in dependence on the size and shape of the road signs to be detected. In this connection, a prediction is taken into account of the size to be expected of road signs such as is described, for example, in the aforesaid European patent application (application number 07 014 924.0).

The comparison of the two respective pixels, for example of the two pixels 19″ or 19′″, in each case takes place by forming the scalar product from the gradient vector ν̅₁ of the one of the two pixels and a gradient vector ν̅₂ₘ which has been created by mirroring of the gradient vector ν̅₂ of the other of the two pixels around a vertical axis.

ν̅₁· ν̅₂ₘ=v₁·v₂ₘ Cos∠( ν̅₁ ν̅₂ₘ)

If the two pixels each belong to one edge, i.e. if the two pixels each have a high gradient value v₁, v₂ₘ, a correspondingly high value results for the product from the two gradient values v₁, v₂ₘ. A high value for this product allows a high degree of specular symmetry of the two pixels with respect to the column 21 to be presumed. If the two pixels admittedly have a high gradient value v₁, v₂ₘ, but if the gradient direction of the two pixels are not oriented in specular symmetry to one another with respect to the column 21, i.e. if the two pixels do not belong to precisely specularly symmetrical edges, a correspondingly smaller cos value (smaller than 1) results so that the vector product and thus the degree of specular symmetry of the two pixels is also reduced.

The vector product is formed for all pixel pairs of the line 23 within the interval [rₘᵢₙ, rₘₐₓ]. The vector products are subsequently added up. If the sum of the vector products of the pixel pairs of line 23 within the interval [rₘᵢₙ, rₘₐₓ] are above a threshold value, the pixel 19′ is recognized as a symmetry center for the pixels of the line 23 within the interval [rₘᵢₙ, rₘₐₓ].

The pixels disposed above and below the pixel 19′ in column 21 are examined accordingly. In this connection, contiguous pixels of the column 21, which were respectively recognized as a symmetry center, form a line of symmetry in the sense of the present invention, with the line of symmetry consequently being associated with an image region which exceeds a predetermined degree of symmetry. For the sake of the robustness of the method, pixels can also sporadically be taken into account in the formation of a line of symmetry which were not recognized as a center of symmetry.

A gradient image 25 is shown in FIG. 3 which is shown in simplified form, which was generated from a gray image value taken by means of the digital video camera and which shows a sign bridge 27 over a highway, with three road signs 29 being mounted to the sign bridge 27. Bushes 31 located to the right to the side of the highway is indicated in the right hand marginal region of the gradient image 25. Lines of symmetry 33 are associated with the images 29 of the road signs in the gradient image 25. Furthermore, further lines of symmetry 35 are shown which are admittedly associated with symmetrical image regions or image portions, but not with images of road signs. The lines of symmetry were each determined as described above.

The round or triangular shapes of the images 29 of the road signs can then be recognized by means of the subsequent shape detection 17. For the lines of symmetry 35, in contrast, the subsequent shape detection 17 or a subsequent classification stage will determine that no road signs are imaged in the image regions or image portions associated with the lines of symmetry 35.

The symmetry detection described above permits the carrying out of a road sign detection faster and with a higher robustness.

1. A method for the detection of a symmetrical object of a known shape in an image of the environment in a range of view of an image taking device, comprising
taking an image by the image taking device;
determining at least one image region including image elements or a part thereof in the taken image or in an image generated from the taken image by image processing, said image region exceeding a preset degree of symmetry;
determining a respective relevant image portion with reference to the at least one image region or the part thereof for a subsequent shape recognition; and
analyzing the relevant image portion using shape recognition to detect a potential image of the symmetrical object.

2. A method in accordance with claim 1, characterized in that the image processing includes edge recognition to provide a gradient image using gradient vectors or a binary edge image.

3. A method in accordance with claim 2, characterized in that the degree of symmetry for the at least one image region is determined by comparison of the gradient vectors of the image elements of the gradient image mutually oppositely disposed with respect to a line.

4. A method in accordance with claim 1 characterized in that the at least one image region has specular symmetry with respect to a preferably vertical line of symmetry.

5. A method in accordance with claim 1, characterized in that the determination of the at least one image region or of the part thereof is only carried out in a selected region of the taken image or generated image.

6. A method in accordance with claim 1, characterized in that the determination of the at least one image region or of the part thereof is carried out while taking account of a prediction on a size to be expected of the image of the object.

7. A method in accordance with claim 1, characterized in that the determination of the at least one relevant image portion is carried out while taking account of a prediction on a size to be expected of the image of the object.

8. A computer program having program code means for carrying out of a method for detection of a symmetrical object of a known shape in an image of the environment in a range of view of an image taking device, comprising
taking an image by the image taking device;
determining at least one image region including image elements or a part thereof in the taken image or in an image generated from the taken image by image processing, said image region exceeding a preset degree of symmetry;
determining a respective relevant image portion with reference to the at least one image region or the part thereof for a subsequent shape recognition; and
analyzing the relevant image portion using shape recognition to detect a potential image of the symmetrical object.

9. A computer program product having program code means which are stored on a computer-legible data carrier for the carrying out of the method in accordance with any one of the claims 1 to 7 when the computer program is carried out on a computer or on a corresponding computer unit.

10. An apparatus for the detection of a symmetrical object of a known shape comprising
a camera device for taking of an image, and
a data processing device configured for analyzing the image, said analyzing including the steps of
determining at least one image region including image elements or a part thereof in the taken image or in an image generated from the taken image by image processing, said image region exceeding a preset degree of symmetry;
determining a respective relevant image portion with reference to the at least one image region or the part thereof for a subsequent shape recognition; and
analyzing the relevant image portion using shape recognition to detect a potential image of the symmetrical object.
